(19) United States
(12) Patent Application Publication
(10) Pub. No.: US 2005/0229404 A1
(43) Pub. Date: Oct. 20, 2005

(54) Combination knife

(75) Inventors: Stig Nordqvist, Eskilstuna (SE); Arne Karlsson, Eskilstuna (SE)

Correspondence Address: ALFRED J MANGELS, 4729 CORNELL ROAD, CINCINNATI, OH, 452412433, US

(73) Assignee: EKA-knivar AB, Eskilstuna (SE)

(21) Appl. No.: 11/071,010

(22) Filed: Mar. 3, 2005

(30) Foreign Application Priority Data
Mar. 4, 2004 (SE) 0400536-9
Mar. 30, 2004 (SE) 0400826-4

(51) Int. Cl. B26B 29/00

(52) U.S. Cl. 30/294

(57) ABSTRACT

A combination knife including a common blade member that carries two different blade elements having cutting edges, each blade element located on a respective side of a pivot joint carried in a knife handle and around which the common blade member can be rotated. One blade element includes a conventional knife-acting cutting edge, while the other blade element includes a stomach-opening cutting edge situated on the upper edge of the blade element when in its use position. A stop is provided for preventing rotation of the common blade member relative to the handle after rotation of the common blade member in a direction such that one of the two cutting edges has been brought to its use position. The cutting edge of the knife-acting blade element and that of the stomach-opening blade element are situated along the same edge of the common blade member.

### BACKGROUND OF THE INVENTION

1. Field of the Invention

The present invention relates to a combination knife, and more particularly to a hunting knife.

2. Description of the Related Art

An animal killed on a hunting expedition is conveniently positioned so that desired parts of the animal, or quarry, can be removed on site. In this regard, the abdominal cavity of the animal is normally cut open and the animal's intestines then removed. There is typically used for this purpose a so-called stomach-opening device, which is a knife-like tool that includes a cutting edge on the upper side of the knife-acting blade. A stomach opener is used, because it is desired to avoid damaging the intestines. It is, of course, possible to use a knife instead of a stomach opener, but this is a more complicated operation.

However, when opening the stomach or abdominal cavity of an animal, a conventional knife is also used in the majority of cases to cut away the animal's skin at certain places. One such place is the region around the animal's groins where tendons need to be severed.

This means that the hunter is required to handle both a stomach opener and a knife while, at the same time, having one hand free for gripping the skin or fur of the animal at the stomach-opening. This makes opening of the stomach difficult to achieve.

This problem is solved by means of the present invention by the provision of a combination knife.

### SUMMARY OF THE INVENTION

The present invention thus relates to a combination knife intended primarily for hunting purposes. The combination knife includes a blade member that is common to and that includes two different blade elements or cutting sections having cutting edges, each of which is located on a respective side of a pivot joint located in a knife handle and about which the common blade member can be rotated. The knife handle has a length that corresponds to the length of the respective cutting sections from the pivot joint to the outer tip of each of the blade ends. One blade element includes a conventional, knife-acting cutting edge with the cutting edge placed on the downwardly-facing edge of the blade element when in its use position. The other blade element includes a stomach-opening blade with the cutting edge placed on the upwardly-facing edge of the blade element when in its use position.

The combination knife includes stop means for preventing further rotation of the common blade member relative to the knife handle, after the blade member has been rotated in a direction in which one of the two cutting sections has been brought to a position for use. The cutting edge of the conventional, knife-acting cutting section and the cutting edge of the stomach-opening cutting section are each located along one and the same edge of the common blade member.

### BRIEF DESCRIPTION OF THE DRAWINGS

The invention will now be described in more detail, partly with reference to exemplifying embodiments of the invention illustrated in the accompanying drawings, in which:

FIG. 1 is a top view of a combination knife according to the invention, with the blade member in the position shown in FIG. 2;

FIG. 2 is a side view of the combination knife;

FIG. 3 is a side view of the combination knife according to a first embodiment, with one handle side member having been removed and with the blade member shown in a first position of use;

FIG. 4 is a side view of the combination knife according to the first embodiment, with one handle side member removed and with the blade member shown in a second position of use;

FIG. 5 is a side view of a second embodiment of the combination knife, with one handle side member having been removed and with the blade member shown in a first position of use;

FIG. 6 is a side view of the combination knife according to FIG. 5, with one handle side member removed and with the blade member in an intermediate position;

FIG. 7 is a side view of the combination knife according to FIG. 5, with one handle side member removed and with the blade member in a second position of use.

### DESCRIPTION OF THE PREFERRED EMBODIMENTS

FIG. 1 shows a combination knife, primarily a hunting knife, seen directly from above. The combination knife includes two spaced, opposed handle side members 1, 2 and a blade member 13 received in the space or gap between the opposed handle side members. The handle side members can be made of wood, plastic, or metal. Sheet metal elements 3, 4 are conveniently placed inwardly of respective handle side members 1, 2, as indicated by dashed lines 5, 6. The combination knife also includes through-penetrating bolts 7, 8 adjacent respective ends of the handle for holding the handle side members 1, 2 of the knife together.

Although the inventive combination knife is intended primarily for hunting purposes, it can also be used for other purposes, such as for fishing, in rescue operations, for culinary purposes, for hobby purposes, and the like.

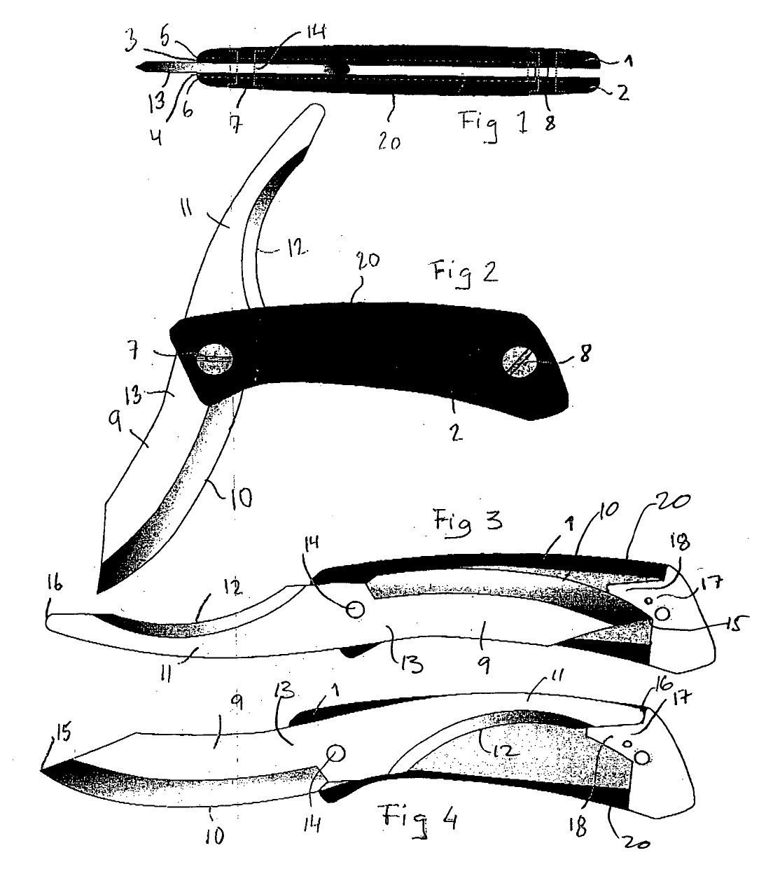

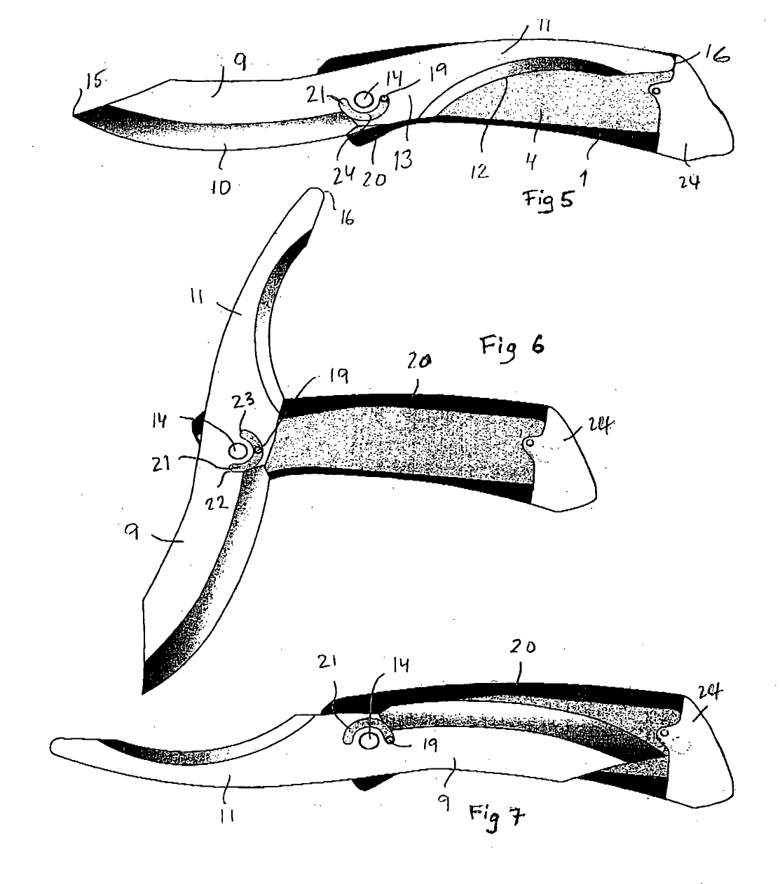

According to the invention, and referring to FIGS. 1 and 2, the combination knife includes a blade member 13 that includes a knife-acting blade element 9 that has a typical cutting edge 10, which is situated on a downwardly-facing edge of the blade member when it is in its use position. The blade member 13 also includes a stomach-opening blade element 11 that has a cutting edge 12 which is situated on an upwardly-facing edge of the blade member when it is in its use position. The two blade elements 9, 11 are part of common blade member 13, wherein the knife-acting blade element 9 and the stomach-opening blade element 11 are each positioned on a respective side of a pivot joint 14 located in the knife handle 20 and around which the common blade member 13 can be rotated. The knife handle 20 has a length that accommodates the lengths of respective blade elements 9, 11 from the pivot joint 14 to the outer ends or tips 15,16 of the respective blade elements (see FIGS. 3 and 4). The cutting edge 10 of the knife-acting blade element 9 and the cutting edge 12 of the stomach-opening blade element 11 are located along one and the same edge of the common blade member 13.

According to one preferred embodiment of the invention, the tip or outer end 16 of the stomach-opening blade element 11 is blunt or rounded.

According to a first embodiment of the invention, as shown in FIGS. 2 through 4, the combined knife includes a stop means 17 for limiting movement of the common blade member 13 in relation to the knife handle 20 when one of the two above-mentioned blade elements has been turned to a use position.

According to one preferred embodiment of the invention, the stop means 17 includes a shoulder 18 that projects inwardly between the handle side members 1, 2 and is fixed relative to the handle 20. The shoulder 18 is located at that end of the knife handle 20 that is opposite to the end at which the pivot joint 14 is located. The shoulder 18 projects inwardly sufficiently far between the handle side members 1, 2 to prevent the common blade member 13 from being rotated beyond the shoulder 18.

FIG. 3 shows the use position of the stomach-opening blade 11, in which the outer end 15 of cutting edge 10 of the blade element 9 lies in abutment with the shoulder 18. When using the stomach-opening blade, the hunter will hold the knife handle 20 and will apply a gripping force to the handle and to the blunt opposite edge of the knife-acting blade element 9 to maintain blade member 13 stationary relative to handle 20, and to cut the skin of the animal through the medium of the cutting edge 12.

FIG. 4 shows the use position of the knife-acting blade element 9, wherein the outer end 16 of the stomach-opening blade element 11 lies in abutment with the shoulder 18. When using the knife-acting blade element 9, the hunter will hold the knife handle 20 and apply a gripping force to the handle and to the blunt opposite edge of the stomach-opening blade element 11 to maintain blade member 13 stationary relative to handle 20 and to cut the body of the animal through the medium of the cutting edge 10.

The shoulder 18 thus has a restraining action both when using the knife-acting blade element 9 and also when using the stomach-opening blade element 11.

According to a second embodiment of the invention, shown in FIGS. 5 through 7, the combination knife includes a different form of stop means for preventing rotation of the common blade member 13 relative to the knife handle 20 when one of the two cutting edges has been brought to a use position. The stop means 24 includes a through-penetrating channel 21 formed in the common blade member 13, the channel extending in an arcuate path with the center of the arc coinciding with the center of the pivot joint 14. A pin 19 extends between the handle side members 1, 2 and through the channel 21, wherein the channel 21 is configured such that when the common blade member 13 is rotated so that the pin 19 abuts one end 22 (see FIG. 6) of the channel 21 or the other end 23 of said channel, the stomach-opening blade element 11 or the knife acting blade 9, respectively, will be in its use position. The pin 19 can extend through the handle side members or only through the sheet metal elements 3, 4.

A shoulder 24 is located between the handle side members on an opposite end of handle 20 relative to the pivot joint 14.

Because the common blade member is rotatably mounted about the pivot joint 14, the hunter is able to switch quickly between the two types of cutting blades, thereby greatly facilitating opening of the animal's abdominal cavity, in comparison with needing to use two individual cutting knives, i.e., a knife including a stomach-opening blade and a separate knife including a conventional knife-acting blade.

It will thus be evident that the invention avoids the problem described in the introduction.

Although different embodiments of the invention have been illustrated and described, it will be apparent that the stop means, among other features, can be designed differently, for instance so that the stop means will latch the blade in both of its directions of rotation when inserted inwardly.

The present invention should not therefore be considered as being limited to the above-described and illustrated exemplifying embodiments thereof, since variations can be made within the scope of the accompanying claims.

1. A combination knife comprising: a common blade member having two different blade elements; a knife handle including a pair of handle side members and a pivot joint between the handle side members and around which the common blade member is rotatable to selectively expose for use one of two different blade elements, wherein the knife handle has an elongated opening of a length sufficient to receive one blade element when another blade element is in a position for use; wherein one blade element includes a knife-acting cutting edge extending along a lower edge of the blade element when that one blade element is in a use position, and the other blade element includes a stomach-opening blade having a cutting edge on an upper edge of the blade element when that other blade element is in a use position; stop means carried by the handle for preventing further rotation of the common blade member relative to the handle after the common blade member has been rotated in a direction in which one of the two blade elements has been brought to a use position; wherein the knife-acting cutting edge and the cutting edge of the stomach-opening blade are located along one and the same edge of the common blade member.

2. A combination knife according to claim 1, wherein the stop means includes a shoulder that is located within the knife handle opening between the handle side members; wherein the shoulder is located adjacent an end of the handle opposite from an end adjacent which the pivot joint is located; and wherein the shoulder extends inwardly within the knife handle opening a distance sufficient to prevent the common blade member from being rotated beyond the shoulder.

3. A combination knife according to claim 1, wherein the stop means includes a through-penetrating channel in the common blade member, the channel extending arcuately with an arc center coinciding with a center of the pivot joint, the stop means including a pin that extends between the handle side members and that passes through the channel, wherein the channel is so positioned that when the common blade member has been rotated so as to bring the pin into abutment with one of two ends of the channel either the knife-acting blade element or the stomach-opening blade element will extend from the handle and be in its use position.

4. A combination knife according to claim 1, wherein the stomach-opening blade element has a blunt outer end.
